(19) United States
(12) Patent Application Publication
(10) Pub. No.: US 2014/0150677 A1
(43) Pub. Date: Jun. 5, 2014

(54) PRESSING DEVICE

(71) Applicants: HON HAI PRECISION INDUSTRY CO., LTD., New Taipei (TW); Fu Tai Hua Industry (Shenzhen) Co., Ltd., Shenzhen (CN)

(72) Inventor: TAI-SHAN ZHU, Shenzhen (CN)

(73) Assignees: HON HAI PRECISION INDUSTRY CO., LTD., New Taipei (TW); Fu Tai Hua Industry (Shenzhen) Co., Ltd., Shenzhen (CN)

(21) Appl. No.: 14/086,882

(22) Filed: Nov. 21, 2013

(30) Foreign Application Priority Data
Dec. 4, 2012 (CN) 2012105117046

(51) Int. Cl. B30B 15/00; B30B 15/30

(52) U.S. Cl. CPC B30B 15/0023; B30B 15/30
USPC 100/223; 100/221

(57) ABSTRACT

A pressing device for pressing workpieces includes a base, a supporting module, a pressing module, and a driving module. The supporting module is arranged on the base and includes at least two carriers for respectively supporting the workpieces. The pressing module includes a pressing portion movable downwards to press the workpiece on one corresponding carrier disposed under the pressing portion. The driving module drives the supporting module to rotate thereby selectively disposing one of the carrier under the pressing portion.

### BACKGROUND

1. Technical Field

The present disclosure relates to pressing devices, and particularly, to a pressing device for pressing workpieces.

2. Description of Related Art

Pressing devices are used for applying a pressing force to workpieces which allows the workpieces to have a desired shape after being pressed. Such a pressing device usually includes only one support carrier to support the workpiece. After pressed, the workpiece needs to be taken out off the support carrier to allow a next workpiece to be placed, which may decrease the efficiency especially when a variety of workpieces need to be pressed.

Therefore, what is needed is a means to solve the problems described above.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is an isometric view of a pressing device in accordance with an exemplary embodiment.

FIG. 2 is an isometric view of a base included in the pressing device of FIG. 1.

FIG. 3 is a partially disassembled isometric view of the pressing device of FIG. 1.

FIG. 4 is an isometric view showing the pressing device of FIG. 1 in one state.

FIG. 5 is similar to FIG. 4, but showing the pressing device in another state.

### DETAILED DESCRIPTION

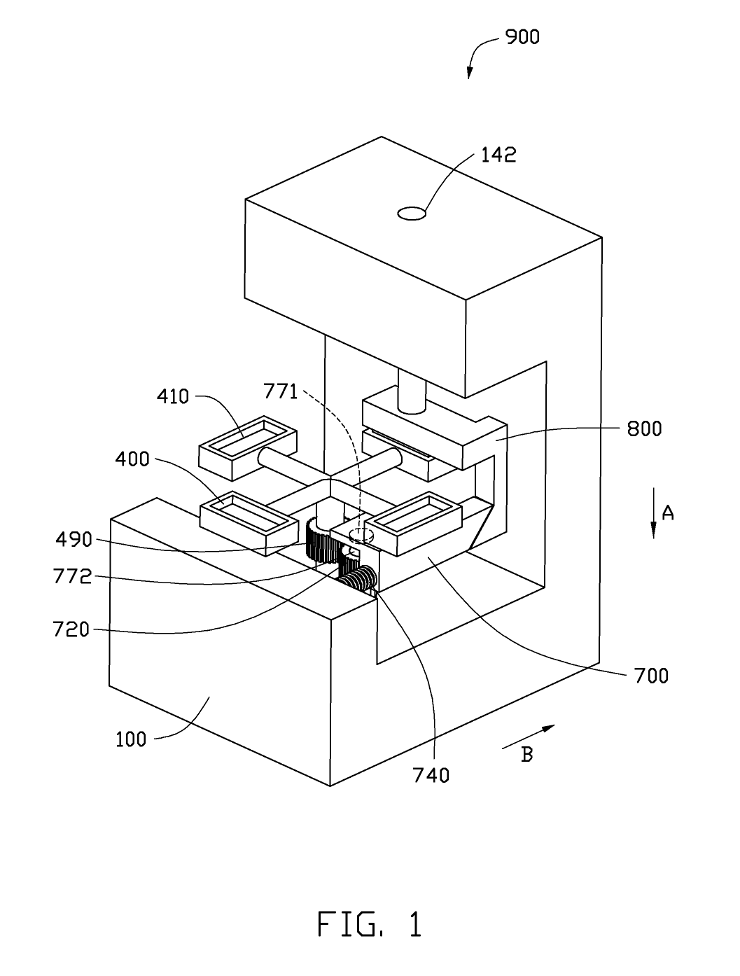

FIG. 1 illustrates a pressing device 900 in accordance with an exemplary embodiment. The pressing device 900 includes a base 100, a pressing module 800, a driving module 700, and a supporting module 400. The pressing module 800, the driving module 700, and the supporting module 400 are arranged on the base 100.

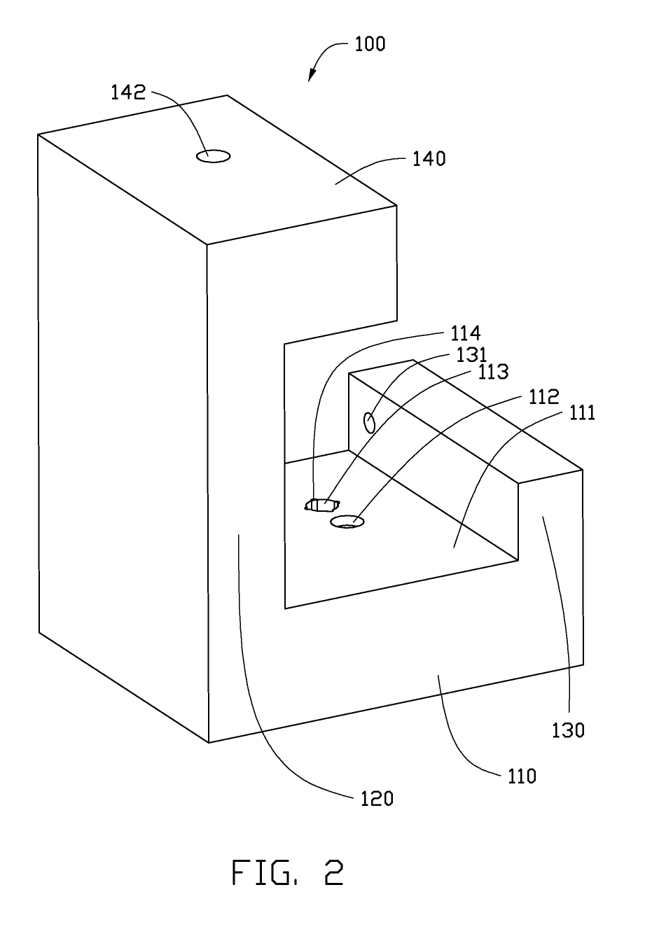

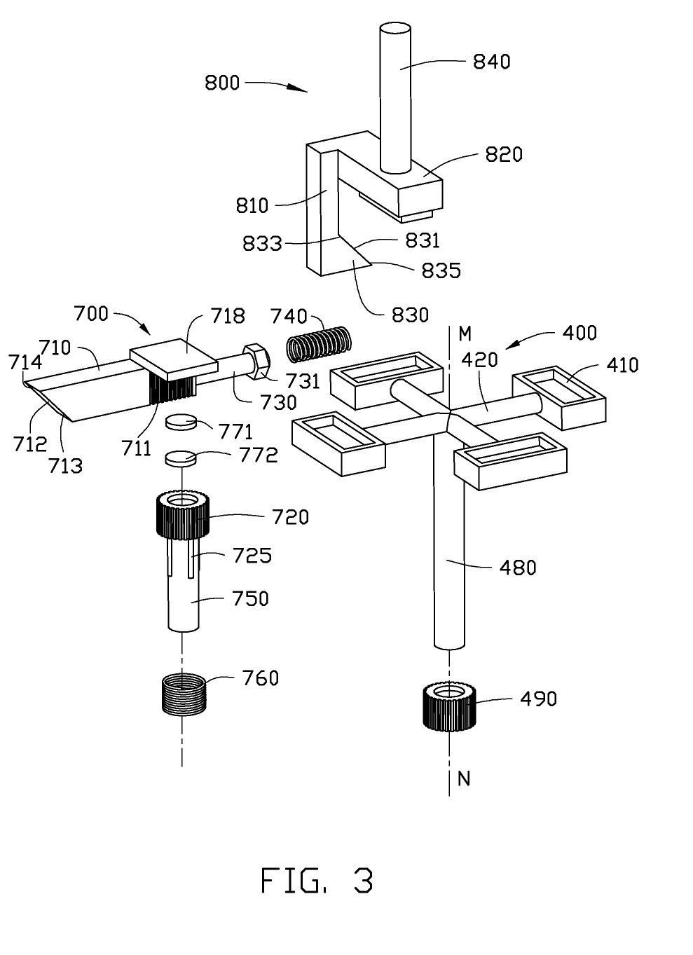

FIGS. 2 and 3 shows that the base 100 includes a bottom portion 110, a first sidewall 120 connected to the bottom portion 110 at one end, a top portion 140 protruding from the first sidewall 120 and parallel to the bottom portion 110, and a second sidewall 130 connected to the bottom portion 110 at another end away from the first sidewall 120. The top portion 140 defines a first through hole 142. The bottom portion 110 defines a first fixing hole 112 and a receiving hole 113. A number of latching grooves 114 are evenly defined in an internal surface of the receiving hole 113. In the embodiment, the number of the latching grooves 114 is four. The second sidewall 130 defines a second fixing hole 131 extending along a direction perpendicular to the first sidewall 120.

The supporting module 400 includes a rotatable shaft 480, a first gear 490 fixed to the rotatable shaft 480, and at least two carriers 410 connected to the rotatable shaft 480 for respectively supporting the workpieces (not shown). The rotatable shaft 480 is rotatably received in first fixing hole 112 and extends along an imaginary axis M-N, thus allowing the carriers 410 to rotate with the rotatable shaft 480. In the embodiment, the supporting module 400 includes four carriers 410 substantially coplanar with each other, and the number of the latching slots 114 is four. In the embodiment, each carrier 410 is connected to the rotatable shaft 480 through a connection bar 420, and the angle between each two adjacent connection bars 420 equals approximately 90 degrees.

The pressing module 800 includes an arm 810, a pressing portion 820 connected to one end of the arm 810, a pushing portion 830 connected to the other end of the arm 810, and a guiding post 840 protruding from the pressing portion 820 toward a direction away from the pushing portion 830. The guiding post 840 passes through the first through hole 142 and is connected to a motor (not shown). When one of the carriers 410 rotates to be disposed under the pressing portion 820, the guiding post 840 pushes the pressing module 800 to move downwards along A direction coaxial with the imaginary axis M-N, when driven by the motor until the pushing portion applies a pushing force to the workpiece supported by the carrier 410. The guiding post 840 further pushes the pressing module 800 to move upwards after pressing the workpiece for a preset time duration. Specifically, the pushing portion 830 includes a first slanted surface 831. The first slanted surface 831 includes a first end 833 and a second end 835, and the first end 833 is arranged between the second end 835 and the arm 810.

The driving module 700 includes a second gear 720 engaged with the first gear 490, and a driving body 710. The driving body 710 includes a rack portion 711 that engages with the second gears 720. When the pressing module 800 moves upwards, the pushing portion 830 pushes the driving body 710 to move away from the pressing module 800, and the second gear 720 drives the first gear 490 to rotate, thereby selectively disposing another carrier 410 under the pressing portion 820.

In the embodiment, the driving module 700 further includes a fixing post 730, a first elastic member 740, and a locking member 731. The fixing post 730 is arranged along B direction which is perpendicular to A direction. One end of the fixing post 730 is connected to the driving body 710, and the other end of the fixing post 730 is slidably received in the second fixing hole 131 and connected with the locking member 731. The first elastic member 740 is coiled around the fixing post 730. One end of the first elastic member 740 abuts against the driving body 710, and the other end of the first elastic member 740 is connected to the locking member 731. The first elastic member 740 is elastically deformed when the driving body 710 moves away from the pressing module 800, and then applies an elastic force to the driving body 710 to push the driving body 710 back.

In the embodiment, the first elastic member 740 is a spring. The driving body 710 includes a second slanted surface 712 opposite to the fixing post 730. The second slanted surface 712 includes a third end 713 and a fourth end 714, and the third end 713 is arranged between the fourth end 714 and the fixing post 730. When the workpiece in one carrier 410 is pressed by the pressing module 800, the first slanted surface 831 comes into contact with the second slanted surface 712. Then, the third end 713 contacts the second end 835, and the fourth end 714 contacts the first end 833. The driving body 710 further includes a cover 718 to cover the second gear 720 when the workpiece in the carrier 410 is pressed by the pressing module 800.

In the embodiment, the driving module 700 further includes a connecting shaft 750, a second elastic member 760, a first magnetic member 771, and a second magnetic member 772. The connecting shaft 750 is rotatably received in the receiving hole 113. The second gear 720 is fixedly coiled around the connecting shaft 750 and rotatable with the connecting shaft 750. The second elastic member 760 is coiled around the connecting shaft 750. One end of the second elastic member 760 is connected to the receiving hole 113, and the other end of the second elastic member 760 is connected with the connecting shaft 750. The connecting shaft 750 and the second gear 720 moves toward the bottom portion 110 by an elastic force of the second elastic member 760.

In the embodiment, the second elastic member 760 is a spring. The first magnetic member 771 is attached to the cover 718. The second magnetic member 772 is attached to the second gear 720. The connecting shaft 750 includes a number of latching posts 725 which can be received in the latching slots 114. When the cover 718 covers the second gear 720, the first magnetic member 771 faces toward the second magnetic member 772, and the magnetic force generated therebetween is greater than the elastic force of the second elastic member 760. When the first magnetic member 771 misaligns with the second magnetic member 772, the magnetic force generated therebetween is less than the elastic force of the second elastic member 760.

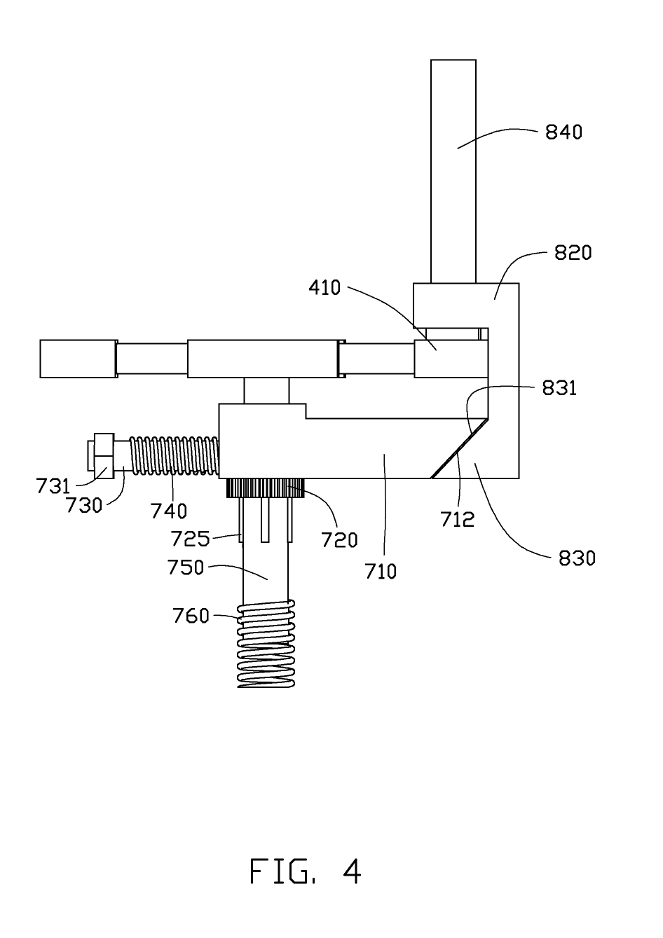

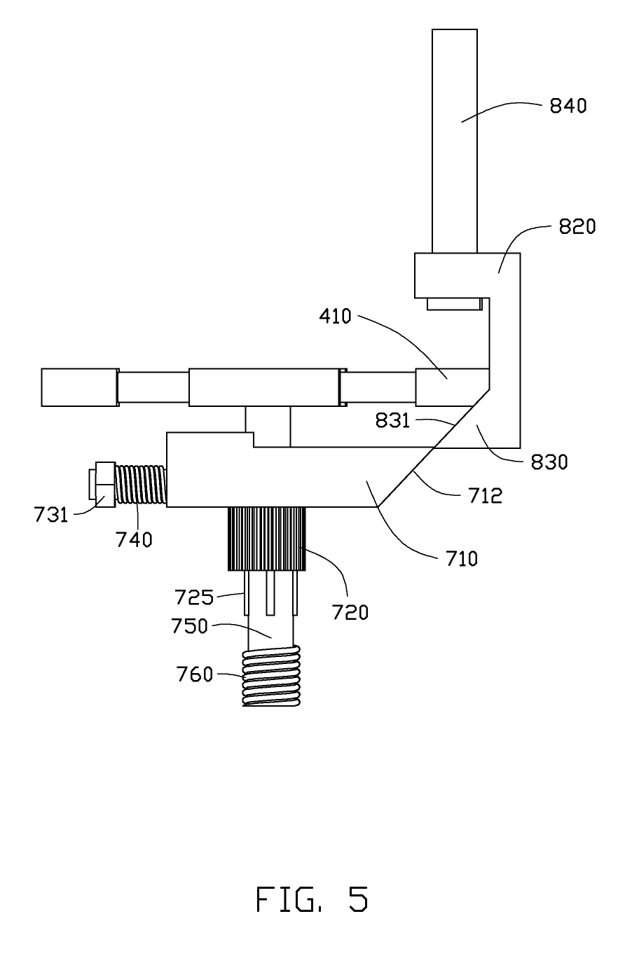

When in use, referring to FIGS. 4 and 5, when the pressing portion 820 moves downwards and presses the workpiece in one carrier 410 after driving by the motor, the second slanted surface 712 contacts the first slanted surface 831. Then, the third end 713 contacts the second end 835, and the fourth end 714 contacts the first end 833. The first magnetic member 771 faces toward the second magnetic member 772. The second gear 720 is engaged with the first gear 490.

When finishing pressing the workpiece in the carrier 410 for a preset time duration, the pressing module 800 moves upwards when driven by the motor. Then, the first slanted surface moves upwards and pushes the driving body 710 to move away from the pressing module 800, thus causing the first elastic member 740 to be elastically compressed. The rack portion 711 drives the second gear 720 to rotate when the driving body 710 moves away from the pressing module 800. The first gear 490 which engages with the second gear 720 rotates with the second gear 720, thereby disposing a next carrier 410 under the pressing portion 820. The cover 718 moves away from the pressing module 800 with the driving body 710 to allow the first magnetic member 771 to misalign with the second magnetic member 772. Then, the elastic force of the second elastic member 760 is greater than the magnetic force between the first and the second magnetic members 771, 772, which pulls the connecting shaft 750 to spirally rotate toward the receiving hole 113 until the latching post 725 is received in one latching slot 114. Then, the second gear 720 disengaged with the rack portion 711 and the first gear 490.

After disposing the next carrier 410 under the pressing portion 820, the pressing portion 820 moves downwards again to press the workpiece in the carrier 410 when driven by the motor. Then, the first elastic member 740 releases to push the driving body 710 to move back. The second slanted surface 712 comes into contact with the first slanted surface 831, the cover 718 covers the second gear 720, and the first magnetic member 771 faces toward the second magnetic member 772. Then, the magnetic force between the first and the second magnetic members 771, 772 pushes the second gear 720 to engage with the rack portion 711 and the first gear 490 again.

With the above configuration, during the pressing module 700 pressing the current workpiece, the operators can put workpieces to be pressed on other carriers 410 or take the workpiece that has already pressed out off the carrier 410, so increasing the efficiency of pressing the workpieces.

It is to be understood, even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A pressing device for pressing workpieces, the pressing device comprising:
a base;
a supporting module arranged on the base and comprising at least two carriers for respectively supporting workpieces;
a pressing module comprising a pressing portion movable downwards to press the workpiece on one corresponding carrier disposed under the pressing portion; and
a driving module to drive the supporting module to rotate thereby selectively disposing one of the carriers under the pressing portion.

2. The pressing device of claim 1, wherein the supporting module further comprises a rotatable shaft and a first gear fixed to the rotatable shaft, the carriers are connected to the rotatable shaft, the rotatable shaft is driven by the first gear to rotate relative to the base.

3. The pressing device of claim 2, wherein the supporting module further comprises at least two connection bars, and each one of the carriers is connected to the rotatable shaft through the corresponding connection bar.

4. The pressing device of claim 2, wherein the pressing module further comprises an arm, a pushing portion, a motor, and a guiding post, the pressing portion and the pushing portion are connected to opposite ends of the arm, the guiding post protrudes from the pressing portion toward a direction away from the pushing portion, the guiding post is connected to the motor to push the pressing module to move downwards, and the pushing portion is configured to push the driving module to move away from the pressing module when the pressing module moves upwards.

5. The pressing device of claim 4, wherein the pushing portion comprises a first slanted surface, the driving body comprises a second slanted surface, the first slanted surface contacts the second slanted surface when the workpiece in the corresponding carrier is pressed by the pressing module, and the second slanted surface pushes the driving body to move away from the pressing module when the pressing module moves upwards.

6. The pressing device of claim 4, wherein the driving module comprises a second gear and a driving body, the second gear is engaged with the first gear, the driving body comprises a rack portion that engages with the second gears, when the pushing portion pushes the driving body to move away from the pressing module, the second gear drives the first gear to rotate.

7. The pressing device of claim 6, wherein the driving module further comprises a connecting shaft and a second elastic member, the connecting shaft is rotatably received in the base, the second gear is fixedly coiled around the connecting shaft and rotatable with the connecting shaft, the second elastic member is coiled around the connecting shaft, and connected to the base and the connecting shaft to pull the connecting shaft and the second gear moves toward the base when the second gear drives the first gear to rotate.

8. The pressing device of claim 7, wherein the base defines a receiving hole and a plurality of latching slots evenly defined in an internal surface of the receiving hole, the connecting shaft is rotatably received in the receiving hole and comprises a plurality of latching posts, one of the at least two carrier rotates to the position under the pressing portion when the connecting shaft spirally rotates toward the receiving hole until one of the plurality of latching posts is received in one corresponding latching slot.

9. The pressing device of claim 7, wherein driving module further comprises a fixing post, a first elastic member, and a locking member, the driving body and the locking member are connected to the fixing post at opposite ends, the first elastic member is coiled around the fixing post and abuts against the driving body and the locking member, the first elastic member is elastically compressed when the driving body move away from the pressing module, and pushes the driving body back when the pressing module moves downwards.

10. The pressing device of claim 9, wherein the driving module further comprises a cover, a first magnetic member attached to the cover, and a second magnetic member attached to the second gear, the cover covers the second gear to cause the first and the second magnetic members faces toward each other when the driving body moves back, and a magnetic force generated therebetween pushes the second gear to engage with the rack portion and the first gear.
